(19) United States
(12) Patent Application Publication
(10) Pub. No.: US 2006/0044676 A1
(43) Pub. Date: Mar. 2, 2006

(54) Hard spacer in recording disk drive and method of making the same

(75) Inventors: Masanori Ueda, Kawasaki (JP); Haruyuki Matsunaga, Kawasaki (JP); Noriyuki Kozakai, Tokyo (JP); Shigefumi Hisatsune, Tokyo (JP); Haruo Sekido, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: FUJITSU LIMITED, Kawasaki (JP); SUMITOMO OSAKA CEMENT CO., LTD., Tokyo (JP); NSK MICRO PRECISION CO., LTD., Fujisawa-shi (JP)

(21) Appl. No.: 11/073,868

(22) Filed: Mar. 8, 2005

(30) Foreign Application Priority Data
Sep. 1, 2004 (JP) 2004-254317

(51) Int. Cl. G11B 17/08

(52) U.S. Cl. 360/98.08

(57) ABSTRACT

A spacer is utilized in a recording disk drive, for example. The spacer is made of a mixed material at least including first inorganic powder having the particle size in a range from 10 μm to 100 μm, second inorganic powder having the particle size in a range from 0.01 μm to 1 μm, and resin material. The resin material is contained in the mixed material at an amount equal to or smaller than 40 volume % to the total amount of the mixed material. The spacer can be formed by molding. The first and second inorganic powder can closely be filled in the resin material. The spacer is thus allowed to enjoy an improved Young's modulus. If the spacer is interposed between recording disks, for example, the spacer serves to sufficiently suppress deformation of the recording disks.

### BACKGROUND OF THE INVENTION

1. Field of the Invention

The present invention relates to a spacer utilized in a recording disk drive such as a hard disk drive (HDD), fore example, and to a method of making the same.

2. Description of the Prior Art

A spindle motor is incorporated within an enclosure of a hard disk drive (HDD), for example. Magnetic recording disks are mounted on the spindle motor. A spacer is interposed between the adjacent magnetic recording disks. A predetermined space is kept between the adjacent magnetic recording disks.

In the case where a glass substrate is utilized in the magnetic recording disk, for example, a spacer made of ceramic material is employed. The coefficient of linear expansion of the spacer is matched with the coefficient of linear expansion of the magnetic recording disks. This serves to avoid a relative displacement between the magnetic recording disks and the spacer even when the temperature rises in the magnetic recording disks and the spacer. Displacement is thus prevented between the magnetic recording disk and the spacer. Run-out is suppressed during the rotation of the magnetic recording disks.

Ceramic powder is molded into an annular green compact under pressure in the production process of making the spacer. The annular green compact is then sintered and gets hardened. However, the annular green compact of ceramic material suffers from variation in the size and shape during the sintering process. Machining process or grinding process should be conducted after the sintering process so as to provide the spacer at a higher dimensional accuracy. It takes a longer time period.

### SUMMARY OF THE INVENTION

It is accordingly an object of the present invention to provide a method of making a spacer at a higher accuracy with less process.

According to a first aspect of the present invention, there is provided a spacer for a recording disk drive, comprising an annular member having upper and lower flat surfaces extending in parallel with each other, wherein said annular member is made of a mixed material at least including first inorganic powder having the particle size in a range from 10 μm to 100 μm, second inorganic powder having the particle size in a range from 0.01 μm to 1 μn, and resin material, said resin material being contained in the mixed material at an amount equal to or smaller than 40 volume % to the total amount of the mixed material.

The spacer is utilized in a recording disk drive such as a hard disk drive, for example. The spacer includes the first inorganic powder having the particle size in a range from 10 μm to 100 μm and the second inorganic powder having the particle size in a range from 0.01 μm to 1 μm. The first and second inorganic powder can closely be filled in the resin material. A so-called microfiller effect can be established. The spacer is thus allowed to enjoy an improved Young's modulus. If the spacer is interposed between recording disks, for example, the spacer serves to sufficiently suppress deformation of the recording disks.

The resin material is contained in the mixed material at an amount equal to or smaller than 40 volume % to the overall volume of the mixed material. The content of the resin material can be minimized enough to realize the injection molding. This contributes to suppression of variation in dimensions and shape of the spacer in the injection molding. The spacer can be formed in the injection molding at a higher accuracy. A so-called near net shape molding can be achieved. Processes can be simplified. The spacer is most suitable to mass production.

In addition, when a glass substrate is employed in a recording disk, the coefficient of linear expansion of the spacer can be matched with that of the glass substrate. A relative displacement can be avoided between the recording disk and the spacer even when the temperature rises in the rotating recording disk and spacer. The recording disk can stably be fixed on a rotation body such as a spindle hub at a higher accuracy. Run-out or eccentricity of the recording disk can be suppressed. An improved recording density can be expected in the recording disk drive.

The first and second inorganic powder may include at least either oxides or continuous solid solutions, said oxides including one element selected from a group consisting of Si, Fe, Al and Ca, said continuous solid solutions including at least two elements selected from the group. A chemically stable and inexpensive material can be employed to provide the first and second inorganic powder. The spacer can be obtained at a lower cost.

The upper and lower flat surfaces may have a flatness equal to or smaller than 2 μm. If the spacer is interposed between recording disks, the first and second annular flat surfaces are allowed to contact the recording disks over an enlarged contact area. The spacer may be covered with an electrically conductive layer. The electrically conductive layer serves to discharge the static electricity from the charged recording disk toward the spacer, for example.

The spacer may be utilized in a recording disk drive such as a hard disk drive as mentioned above. The recording disk drive may include a rotation body, recording disks mounted on the rotation body; and a spacer mounted on the rotation body between the recording disks, said spacer having upper and lower flat surfaces extending in parallel with each other. In this case, the spacer maybe made of a mixed material at least including first inorganic powder having the particle size in a range from 10 μm to 100 μm, second inorganic powder having the particle size in a range from 0.01 μm to 1 μm, and resin material, said resin material being contained in the mixed material at an amount equal to or smaller than 40 volume % to the total amount of the mixed material.

A specific method may be provided to make the aforementioned spacer. The method may include preparing a mixed material at least including first inorganic powder having particle size in a range from 10 μm to 100 μm, second inorganic powder having particle size in a range from 0.01 μm to 1 μm, and resin material, said resin material being contained in the mixed material at an amount equal to or smaller than 40 volume % to a total amount of the mixed material; and molding an annular member based on the mixed material, said annular member having upper and lower annular flat surfaces extending in parallel with each other.

The spacer is made of the mixed material containing the first inorganic powder having the particle size in a range from 10 μm to 100 μm and the second inorganic powder having the particle size in a range from 0.01 μm to 1 μm in the aforementioned method. The first and second inorganic powder is closely filled in the resin material. A so-called microfiller effect can be established. The spacer is thus allowed to enjoy an improved Young's modulus. The spacer is prevented from suffering from creep.

The resin material is contained in the mixed material at an amount equal to or smaller than 40 volume % to the overall volume of the mixed material. The content of the resin material can be minimized enough to realize the injection molding. This contributes to suppression of variation in dimensions and shape of the spacer in the injection molding. The spacer can be formed in the injection molding at a higher accuracy. A so-called near net shape molding can be achieved. Processes can be simplified. The spacer is most suitable to mass production.

The method allows employment of the first and second inorganic powder including at least either oxides or continuous solid solutions, said oxides including one element selected from a group consisting of Si, Fe, Al and Ca, said continuous solid solutions including at least two elements selected from the group. A chemically stable and inexpensive material can be employed to provide the first and second inorganic powder. The spacer can be obtained at a lower cost.

The method may further comprise effecting grinding process on the annular member so as to establish a flatness equal to or smaller than 2 μm on the upper and lower annular flat surfaces. As described above, a higher Young's modulus can be established in the spacer. A so-called springback can be prevented in the annular member during grinding process. The flatness equal to or smaller than 2 μm can be established over the first and second annular flat surfaces of the annular member based on grinding process.

The method may further comprise effecting plating process on the annular member with an electrically conductive material. The annular member may be covered with the electrically conductive layer. The electrically conductive layer serves to avoid generation of dusts out of voids or depressions defined on the surface of the annular member. The electrically conductive layer also serves to establish electrical conductivity of the annular member. The method may further comprise subjecting the annular member to at least any one of blasting process, etching process and surface activating process prior to the plating process.

The mixed material may be formed in a cavity of a die, said cavity being defined between parallel annular flat inner surfaces of the die. The mixed material may be injected into the cavity through gates located at equally spaced positions along a predetermined datum circle around the axis connecting the centers of the parallel annular flat inner surfaces. Since the gates are located at equally spaced locations, the mixed material is allowed to flow into the cavity at a uniform velocity. An unbalanced afflux of the mixed material can be avoided in the cavity. A final product molded in the cavity is thus allowed to enjoy an improved dimensional accuracy.

Knock pins may be located for inward and outward movements relative to the cavity at equally spaced positions along a predetermined datum circle around the axis connecting the centers of the parallel annular flat inner surfaces. Since the knock pins are arranged at equally spaced locations, the annular member is allowed to equally receive the urging force from the individual knock pins. Imbalance of the urging force is avoided. A partial deformation can thus be prevented in the annular member.

Alternatively, the mixed material may be injected into the cavity through a gate extending along the entire predetermined datum circle set around the axis connecting the centers of the parallel annular flat inner surfaces. Since the gate opens along the entire predetermined datum circle, the mixed material is allowed to flow into the cavity at a uniform velocity. An unbalanced afflux of the mixed material can be avoided in the cavity. A final product molded in the cavity is thus allowed to enjoy an improved dimensional accuracy.

A knock pin may be located for inward and outward movements relative to the cavity, said knock pin defining one of the parallel annular flat inner surfaces over a surface of the knock pin itself. The annular member is allowed to equally receive the urging force from the knock pin. Imbalance of the urging force is avoided. A partial deformation can thus be prevented in the annular member. The knock pin may be shaped in a disk, an annular form, or the like.

According to a second aspect of the present invention, there is provided a spacer for a recording disk drive, comprising an annular member having upper and lower flat surfaces extending in parallel with each other, wherein said annular member is made of a mixed material including a constituent and resin material, said constituent getting hardened based on reaction with a predetermined material, said resin material being contained in the mixed material at an amount equal to or smaller than 40 volume % to the total amount of the mixed material.

The resin material is contained in the mixed material at an amount equal to or smaller than 40 volume % to the overall volume of the mixed material. The content of the resin material can be minimized enough to realize the injection molding. This contributes to suppression of variation in dimensions and shape of the spacer in the injection molding. The spacer can be formed in the injection molding at a higher accuracy. A so-called near net shape molding can be achieved. Processes can be simplified. The spacer is most suitable to mass production.

The spacer may be utilized in a recording disk drive such as a hard disk drive. The recording disk drive may include a rotation body, recording disks mounted on the rotation body; and a spacer mounted on the rotation body between the recording disks, said spacer having upper and lower flat surfaces extending in parallel with each other. In this case, the spacer may be made of a mixed material including a constituent and resin material, said constituent getting hardened based on reaction with a predetermined material, said resin material being contained in the mixed material at an amount equal to or smaller than 40 volume % to a total amount of the mixed material.

A specific method may be provided to form the spacer. The method may comprise preparing a mixed material including a constituent and resin material, said constituent getting hardened based on reaction with a predetermined material, said resin material being contained in the mixed material at an amount equal to or smaller than 40 volume % to the total amount of the mixed material; and molding an annular member based on the mixed material, said annular member having upper and lower annular flat surfaces extending in parallel with each other.

The method allows employment of the resin material contained in the mixed material at an amount equal to or smaller than 40 volume % to the overall volume of the mixed material. The content of the resin material can be minimized enough to realize the injection molding. This contributes to suppression of variation in dimensions and shape of the spacer in the injection molding. The spacer can be formed in the injection molding at a higher accuracy. A so-called near net shape molding can be achieved. Processes can be simplified. The spacer is most suitable to mass production.

The method may further comprise subjecting the annular member to maturing process utilizing at least any one of steam under normal atmosphere, steam under a pressurized atmosphere, and hot water. If the constituents include a hydraulic constituent, the water is supplied to the annular member based on the maturing process. The hydraulic constituent gets cured or hardened based on reaction with the water. The maturing process serves to promote setting or hardening of the hydraulic constituent.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive (HDD) as an example of a recording disk drive according to an embodiment of the present invention;

FIG. 2 is a sectional view taken along the line 2-2 in FIG. 1, for schematically illustrating the structure of a spindle motor;

FIG. 3 is a perspective view schematically illustrating the structure of an annular spacer according to an embodiment of the present invention;

FIG. 4 is an enlarge partial sectional view schematically illustrating the structure of an injection molding machine according to a specific example;

FIG. 5 is an enlarged partial sectional view of the injection molding machine for schematically illustrating the arrangement of gates and knock pins;

FIG. 6 is an enlarge partial sectional view schematically illustrating the structure of an injection molding machine according to another specific example;

FIG. 7 is an enlarged partial sectional view of the injection molding machine for schematically illustrating the arrangement of a gate and a knock pin;

FIG. 8 is an enlarge partial sectional view schematically illustrating the structure of an injection molding machine according to still another specific example;

FIG. 9 is a sectional view for schematically illustrating the structure of an annular spacer according to a modification of the embodiment;

FIG. 10 is a sectional view for schematically illustrating the structure of an annular spacer according to another embodiment of the present invention;

FIG. 11 is a perspective view for schematically illustrating the structure of an annular spacer according to another modification of the embodiment;

FIG. 12 is a perspective view for schematically illustrating the structure of an annular spacer according to another modification of the embodiment; and

FIG. 13 is a perspective view for schematically illustrating the structure of an annular spacer according to another modification of the embodiment.

### DESCRIPTION OF THE PREFERRED EMBODIMENTS

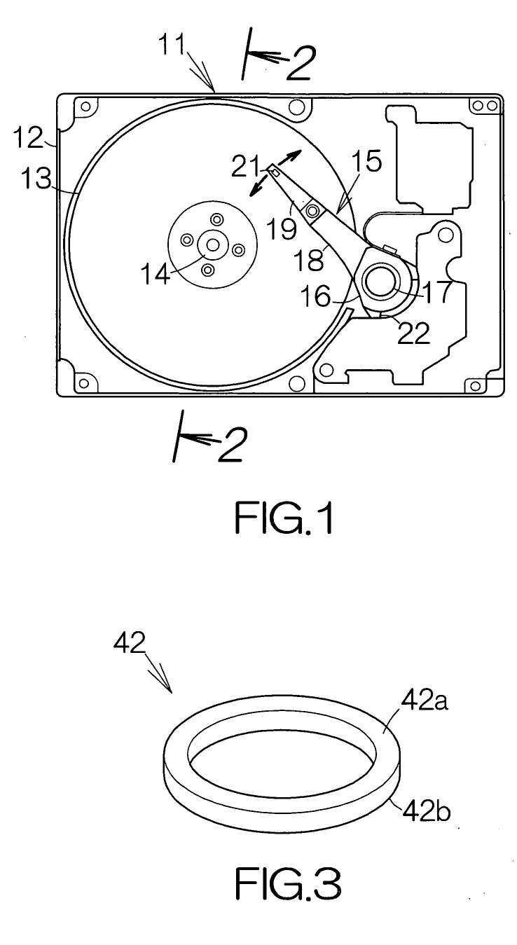

FIG. 1 schematically illustrates the inner structure of a hard disk drive (HDD) 11 as an example of a recording disk drive or storage device according to an embodiment of the present invention. The HDD 11 includes a box-shaped main enclosure 12 defining an inner space of a flat parallelepiped, for example. At least one magnetic recording disk 13 is incorporated within the inner space. A glass substrate may be utilized for the magnetic recording disk or disks 13, for example. The magnetic recording disk or disks 13 is mounted on the driving shaft of a spindle motor 14. The spindle motor 14 is allowed to drive the magnetic recording disk or disks 13 for rotation at a higher revolution speed such as 7,200 rpm, 10,000 rpm, 15,000 rpm, or the like, for example. A cover, not shown, is coupled to the main enclosure 12 so as to define the closed inner space between the main enclosure 12 and the cover itself.

A head actuator 15 is also incorporated in the inner space of the main enclosure 12. The head actuator 15 includes an actuator block 16. The actuator block 16 is coupled to a vertical support shaft 17 for relative rotation. The vertical shaft 17 stands upright from the bottom plate of the main enclosure 12, for example. Rigid actuator arms 18 are defined in the actuator block 16 so as to extend in the horizontal direction from the vertical support shaft 17. The actuator arms 18 are related to the front and back surfaces of the individual magnetic recording disk or disks 13. The actuator block 16 may be made of aluminum. Metal extrusion process may be employed to form the actuator block 16.

Head suspensions 19 are fixed to the corresponding tip ends of the actuator arms 18. The head suspensions 19 further extend in the forward direction from the actuator arms 18. A flying head slider 21 is supported on front end of the head suspension 19. The flying head slider 21 is in this manner coupled to the actuator block 16. The flying head slider 21 is opposed to the surface of the magnetic recording disk 13.

An electromagnetic transducer, not shown, is mounted on the flying head slider 21. The electromagnetic transducer may include a read element and a write element. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example. The write element may include a thin film magnetic head designed to write magnetic bit data into the magnetic recording disk 13 by utilizing a magnetic field induced at a thin film coil pattern.

The head suspension 19 serves to urge the flying head slider 21 toward the surface of the magnetic recording disk 13. When the magnetic recording disk 13 rotates, the flying head slider 21 is allowed to receive airflow generated along the rotating magnetic recording disk 13. The airflow serves to generate a positive pressure or lift and a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

A drive source such as a voice coil motor (VCM) 22 is connected to the actuator block 16, for example. The drive source 22 serves to drive the actuator block 16 for rotation around the support shaft 17. The rotation of the actuator block 16 induces the swinging movement of the actuator arms 18 and the head suspensions 19 around the support shaft 17. When the actuator arm 18 is driven to swing around the support shaft 16 during the flight of the flying head slider 21, the flying head slider 21 is allowed to cross the surface of the magnetic recording disk 13 in the radial direction. As conventionally known, in the case where two or more of the magnetic recording disks 13 are incorporated within the main enclosure 12, a pair of the actuator arm 18 and a pair of the head suspension 19 are disposed between the adjacent magnetic recording disks 13.

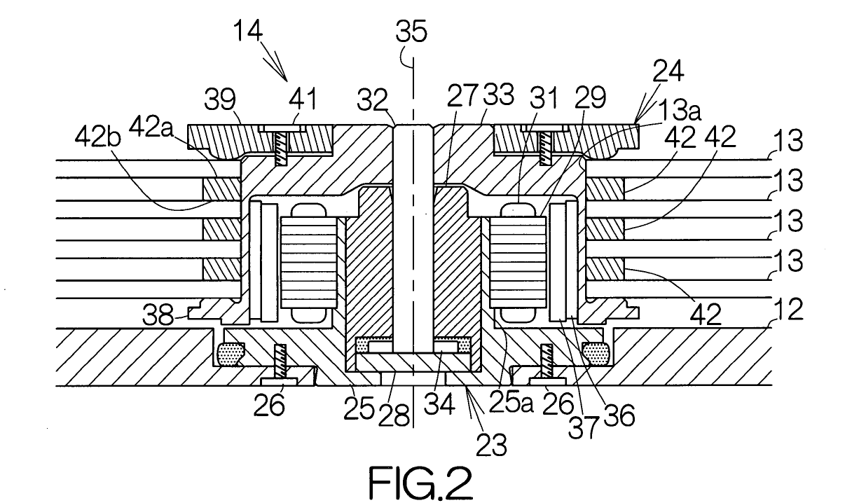

FIG. 2 illustrates the structure of a spindle motor 14. The spindle motor 14 includes a stator 23 and a rotor 24. The rotor 24 is supported in the stator 23 for relative rotation. The stator 23 includes a bracket 25 received on the main enclosure 12. Screws 26 are employed to fix the bracket 25 to the main enclosure 12, for example. A cylindrical portion 25a is formed on the bracket 25. The cylindrical portion 25a stands upright from the upper surface of the basement of the bracket 25.

A sleeve 27 is received in the cylindrical portion 25a of the bracket 25. A cylindrical space is defined in the sleeve 27. A thrust plate 28 is inserted into the sleeve 27 based on press fit. The thrust plate 28 is designed to airtightly close the lower opening of the sleeve 27. A set of cores 29 is fixed to the outer surface of the cylindrical portion 25a. A coil 31 is wound around the individual core 29 so as to form an electromagnet. The core 29 may be made of layered metallic thin plate, for example.

The rotor 24 includes a rotation shaft 32 and a spindle hub 33 serving as a rotation body according to the present invention. The spindle hub 33 is mounted on the rotation shaft 32. The rotation shaft 32 is received in the space inside the sleeve 27. Fluid such as lubricant oil is filled in a clearance between the rotation shaft 32 and the inner surface of the sleeve 27. The rotation shaft 32 is in this manner supported in the sleeve 27. A disk-shaped thrust flange 34 is fixed to the lower end of the rotation shaft 32. The lower surface of the thrust flange 34 is opposed to the upper surface of the thrust plate 28. Lubricant oil is also filled in a clearance between the thrust flange 34 and the thrust plate 28.

An annular inner space is defined within the spindle hub 33. The stator 23 is contained within the inner space. The rotation shaft 32 is inserted into the ceiling wall of the spindle hub 33. An adhesive may be utilized to fix the rotation shaft 32 to the spindle hub 33. The spindle hub 33 is in this manner coupled to the bracket 25 for relative rotation around a longitudinal axis 35 of the rotation shaft 32.

The cylindrical inner surface of the spindle hub 33 is opposed to the cylindrical outer surface of the cylindrical portion 25a. Yokes 36 and permanent magnets 37 are fixed to the inner surface of the spindle hub 33. The permanent magnets 37 are thus opposed to the coils 31. When electric current is supplied to the coils 31, a magnetic field generated at the coils 31 drives the spindle hub 33 around the longitudinal axis 35.

Four magnetic recording disks 13, for example, are mounted on the spindle hub 33. A through hole 13a is formed in the individual magnetic recording disk 13 at the center of the disk 13. The through hole 13a receives the spindle hub 33. An outward flange 38 is formed at the lower end of the spindle hub 33. The lowest magnetic recording disk 13 is received on the flange 38. A clamp 39 is attached to the tip end of the spindle hub 33. Four screws 41 are employed to fix the clamp 39 to the spindle hub 33, for example. The magnetic recording disks 13 are held between the flange 38 and the clamp 39.

An annular spacer 42 is interposed between the individual adjacent ones of the magnetic recording disks 13 around the spindle hub 33. The annular spacer 42 serves to keep a space between the adjacent magnetic recording disks 13. Referring also to FIG. 3, the annular spacer 42 is made of an annular member having upper and lower or first and second annular flat surfaces 42a, 42b extending in parallel with each other. The first and second annular flat surfaces 42a, 42b are designed to receive the front and back surfaces of the magnetic recording disks 13. Here, the annular member has a circular ring shape.

The flatness of the first and second annular flat surfaces 42a, 42b is set equal to or smaller than 2 μm in the annular spacer 42. The first and second annular flat surfaces 42a, 42b are thus allowed to contact the magnetic recording disks 13 over an enlarged contact area. The surface of the annular member is covered with an electrically-conductive layer. The electrically-conductive layer serves to discharge the static electricity from the charged magnetic recording disks 13 toward the annular spacer 42, for example.

The annular spacer 42 may be made of a mixed material including inorganic filler and resin material. The resin material may be contained in the mixed material at an amount equal to or smaller than 40 volume % to the total volume of the annular spacer 42. In particular, the content of the resin material set equal to or smaller than 35 volume % contributes to an improved Young's modulus of the annular spacer 42. Injection molding, extrusion or press molding may be employed to form the annular spacer 42, for example. A method of making the annular spacer 42 will be described later in detail.

The inorganic filler includes at least first and second inorganic powder. The first inorganic powder has the particle size in a range from 10 μm to 100 μm. The second inorganic powder has the particle size in a range from 0.01 μm to 1 μm, for example. The ratio of the first inorganic powder to the second inorganic powder may be set at 54 to 46 by volume. The first and second inorganic powder may include an oxide including one element selected from a group consisting of Si, Fe, Al and Ca, for example. Alternatively, the first and second inorganic powder may include a continuous solid solution including at least two elements selected from a group consisting of Si, Fe, Al and Ca, for example.

Specifically, the first and second inorganic powder includes hydraulic powder, for example. Here, the hydraulic powder is defined as powder getting cured or hardened based on reaction with a predetermined material such as water, for example. The hydraulic powder includes at least one selected from a group consisting of portland cement, calcium silicate, calcium aluminate, calcium fluoroaluminate, calcium sulfuraluminate, calcium aluminoferrite, calcium phosphate, calcium sulfate semihydrate, anhydride, and self-hardening calcined lime, for example.

The first and second inorganic powder may include non-hydraulic powder, for example. The non-hydraulic powder may be defined as powder that fails to get cured or hardened based on mixture with water. The non-hydraulic powder may include powder getting hardened based on reaction with a material other than water. The non-hydraulic powder may include powder generating a product based on reaction of its constituent eluting in an alkaline state or an acid state or under a high pressure steam atmosphere with other constituent. The non-hydraulic powder may be at least one selected from a group consisting of calcium hydroxide, calcium sulfate dihydrate, calcium carbonate, slag, fly ash, silica, clay, and silica fume powder.

The resin material may include at least either thermoplastic resin material or thermosetting resin material. The thermoplastic resin material may be any one selected from a group consisting of polyethylene, polypropylene, polyvinyl chloride, polystyrene, acrylonitrile butadiene styrene (ABS resin), polyamide, polyacetal, polyester, polycarbonate, modified polyphenylene ether, polysulfone, polyarylate, polyetherimide, polyamideimide, polyphenylene sulfide, liquid crystal polyester, PEEK (polyether ether ketone), PEN (polyethylene naphthalate), paraffin wax, montan wax, carnauba wax, fatty acid ester, glycerite, modified wax, and silane modified polyolef in polymer, for example. The thermosetting resin material may be any one selected from a group consisting of phenolic resin, urea resin, melamine resin and alkyd resin. In particular, a thermoplastic resin material having a molecular weight equal to or larger than 10,000 is preferably employed as the resin material. The molecular weight may be set to avoid difficulty in mixing the constituents in the mixed material.

The annular spacer may further contain a reinforcing material and an electrically-conductive material. The reinforcing material may be at least any one selected from a group consisting of glass fiber, carbon fiber, aramid fiber and potassium titanate whisker. The reinforcing material serves to improve the mechanical strength and thermal characteristic of the annular spacer 42. The electrically-conductive material may include ferrous oxide, nickel oxide, and the like. The electrically-conductive material serves to establish an electrically conductive property of the annular spacer 42.

Now, assume that the magnetic disks 13 start rotating. When electric current is supplied to the coils 31, the coils 31 induce a driving force in response to reaction to the permanent magnets 37. When the rotation shaft 32 starts rotating, the oil flows along the inner surface of the sleeve 27. The oil thus generate a dynamic pressure. The dynamic pressure serves to keep a predetermined space between the outer surface of the rotation shaft 32 and the inner surface of the sleeve 27. A constant space is also kept between the lower surface of the thrust flange 34 and the upper surface of the thrust plate 28. The rotation axis of the rotation shaft 32 coincides with the longitudinal axis 35. The magnetic recording disks 13 in this manner keeps rotating. When the supply of the electric current is terminated, the magnetic recording disks 13 stop rotating. The oil stops flowing. The dynamic pressure disappears. The lower end of the rotation shaft 32 is received on the upper surface of the thrust plate 28.

The annular spacer 42 includes the first inorganic powder having the particle size in a range from 10 μm to 100 μm and the second inorganic powder having the particle size in a range from 0.01 μm to 1 μm. The first and second inorganic powder can closely be filled in the annular spacer 42, as described later in detail. A so-called micro filler effect can be established. The annular spacer 42 is thus allowed to enjoy an improved Young's modulus. The annular spacers 42 serve to sufficiently suppress deformation of the magnetic recording disks 13.

Moreover, the coefficient of linear expansion of the annular spacer 42 can be matched with that of the glass substrate of the magnetic recording disks 13. Even if the temperature rises in the magnetic recording disks 13 and/or the annular spacer 42 during the rotation, relative displacement can be avoided between the magnetic recording disks 13 and the annular spacers 42. The magnetic recording disks 13 can be set stable on the spindle hub 33 at a higher accuracy. Accordingly, the magnetic recording disks 13 are prevented from run-out. An improved recording density can be expected in the HDD 11.

In addition, the first and second inorganic powder may contain an oxide including one element selected from a group consisting of Si, Fe, Al and Ca. Alternatively, the first and second inorganic powder may contain a continuous solid solution including at least two elements selected from a group consisting of Si, Fe, Al and Ca. A chemically stable and inexpensive material can be employed to provide the first and second inorganic powder. The annular spacer 42 can be obtained at a lower cost.

Next, description will be made on a method of making the annular spacer 42. The mixed material is first prepared. The mixed material contains the first and second inorganic powder and the resin material. Here, the hydraulic powder is employed as the first inorganic powder. The non-hydraulic powder is employed as the second inorganic powder. The thermoplastic resin material is employed as the resin material. The first and second inorganic powder and the resin material are uniformly mixed in a conventional method. The content of the resin material is set equal to or smaller than 40 volume % to the total volume of the mixed material. The mixed material may have been prepared in the form of pellets. A silane coupling agent, the aforementioned reinforcing material and electrically-conductive material may be added to the mixed material.

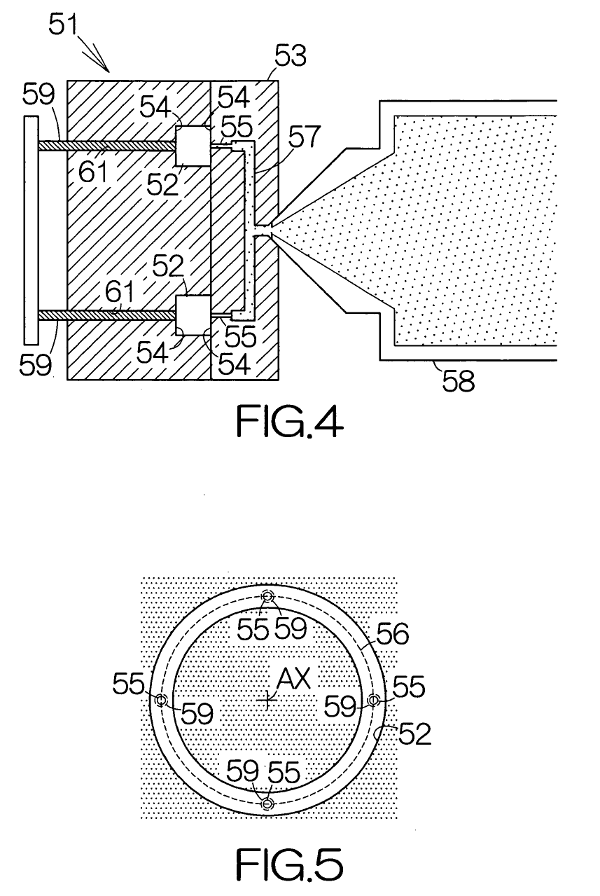

The mixed material is then shaped into an annular form. A conventional method may be utilized to from the annular member. Here, injection molding is employed. As shown in FIG. 4, an injection molding machine 51 is utilized in the injection molding, for example. The injection molding machine 51 includes a die 53 defining anannular cavity 52 inside. The cavity 52 is defined between parallel annular flat inner surfaces 54, 54 of the die 53. The parallel annular flat inner surfaces 54, 54 extend in parallel with each other.

Gates 55 are formed in the die 53 so as to open at one of the parallel annular flat inner surfaces 54. Referring also to FIG. 5, the gates 55 are arranged at equally spaced positions along a predetermined datum circle 56 around an axis AX connecting the centers of the parallel annular flat inner surfaces 54, 54. Here, the gates 55 are located at four positions. Alternatively, the gate 55 may be located at a sole position. The less the gates 55 are located, the less waste is generated. The gate 55 is also connected to a runner 57 defined in the die 53. The runner 57 extends through the die 53. The outer end of the runner 57 is connected to an injection machine 58. The injection machine 58 serves to inject the mixed material through a nozzle into the runner 57 under a melted condition. The mixed material is supplied from a hopper, not shown, to the injection machine 58.

Knock pins 59 are located to protrude from the other of the parallel annular flat inner surfaces 54. The knock pins 59 are inserted into through holes 61 defined in the die 53. Referring also to FIG. 5, the knock pins 59 are arranged at equally spaced locations along the datum circle 56 around the axis AX. The knock pins 59 are allowed to enter and withdraw from the cavity 52. Here, the knock pins 59 are located at four positions. The knock pins 59 may be located at positions corresponding to the positions of the gates 55, for example. The gates 55 and the knock pins 59 may alternatively be located at six locations equally spaced from each other along the datum circle 56.

The mixed material is heated within the injection machine 58. The mixed material gets melted. The melted mixed material flows into the runner 57 from the injection machine 58. The melted mixed material is introduced into the cavity 52 through the gates 55. Since the gates 55 are located at four locations equally spaced in the die 53, the melted mixed material is allowed to flow into the cavity 52 at a uniform velocity. An unbalanced afflux of the melted mixed material can be avoided in the cavity 52. A final product molded in the cavity 52 is thus allowed to enjoy an improved dimensional accuracy.

When the cavity 52 is filled up with the melted mixed material, the mixed material is kept in the die 53 for a predetermined period. The die 53 is kept at a constant set temperature. The melted mixed material is thus cooled down. The thermoplastic resin material in the melted mixed material gets cured or hardened. The first and second inorganic powder is closely filled into the resin material. The annular member is in this manner formed in the cavity 52.

The die 53 is thereafter divided at one of the parallel annular flat inner surfaces 54. The knock pins 59 are urged against the annular member. The annular member is thus pushed out of the die 53. Since the knock pins 59 are arranged at equally spaced locations, the annular member is allowed to equally receive the urging force from the individual knock pins 59. Imbalance of the urging force is avoided. A partial deformation can thus be prevented in the annular member. The annular member is then removed from the die 53. The annular member is allowed to have the first and second annular flat surfaces 42a, 42b as described above.

The first and second annular flat surfaces 42a, 42b are then subjected to grinding process. A double surface grinding machine is employed to realize the grinding process. Grinders are simultaneously contacted with the first and second annular flat surfaces 42a, 42b. The number or velocity of the revolution for the grinders maybe controlled in accordance with dimensions of the annular spacer 42.

Surface treatment is thereafter effected on the surface of the annular member including the first and second annular flat surfaces 42a, 42b. For example, blasting process, auxiliary wash, etching process, surface activating process are effected. Grinding grains are insuff lated onto the surface of the annular member in the blasting process, with the assistance of a pressurized air, for example. The size and material of the grinding grains may properly be selected. The surface of the annular member thus gets rough. The annular member is then washed with distilled water, for example. The grinding grains are thus removed from the surface of the annular member.

Etching process is then effected on the surface of the annular member. The annular member is dipped into a solution containing hydrofluoric acid for a predetermined time duration, for example, in the etching process. Surface activating process is then applied to the surface of the annular member. The annular member may be dipped into a solution containing palladium for a predetermined time period, for example. The annular member is there after washed with distilled water. The blasting process, the etching process and the surface activating process serve to improve the strength of cohesion of a nickel plating layer covering over the surface of the annular member.

Plating process utilizing an electrically-conductive material is then effected on the surface of the annular member including the first and second annular flat surfaces 42a, 42b. Here, electroless nickel plating is conducted. The annular member is dipped into a solution containing nickel for a predetermined time duration. The surface of the annular member is covered with an nickel plating layer. The nickel plating layer or electrically-conductive layer serves to avoid generation of dusts out of voids or depressions defined on the surface of the annular member. The electrically-conductive layer also serves to establish electrical conductivity of the annular member. The annular member is subjected to ultrasonic washing utilizing pure water after the electroless nickel plating. The annular member is then dried. The annular spacer 42 is in this manner produced.

The annular spacer 42 is made of the mixed material containing the first inorganic powder having the particle size in a range from 10 μm to 100 μm and the second inorganic powder having the particle size in a range from 0.01 μto 1 μm in the aforementioned method. The first and second inorganic powder is closely filled into the resin material. A so-called microfiller effect can be established. The annular spacer 42 is thus allowed to enjoy an improved Young's modulus. The annular spacer 42 is prevented from suffering from creep.

A deformation by springback can be prevented in the annular member during the grinding process since a higher Young's modulus is established in the annular member as described above. The flatness equal to or smaller than 2 μm can be established over the first and second annular flat surfaces 42a, 42b of the annular spacer 42 based on the grinding process.

The resin material is contained in the mixed material at an amount equal to or smaller than 40 volume % to the overall volume of the mixed material. The content of the resin material can be minimized enough to realize the injection molding. This contributes to suppression of variation in dimensions and shape of the annular member. The annular member can be formed in the injection molding at a higher accuracy. A so-called near net shape molding can be achieved. Dimensional variation can be suppressed to a level equal to or smaller than 0.2% in the annular member. Processes can be simplified. The annular member or annular spacer 42 is most suitable to mass production.

On the other hand, sintering process is required to form the annular spacer based on a conventional ceramic material. The annular member of the ceramic material often suffers from a dimensional variation larger than 10%. The dimensions of the annular member after the sintering process largely deviates from the designed dimensions. The first and second annular flat surfaces should be subjected to grinding process for a longer period as compared with the present invention. The inner and outer periphery of the annular member should also be subjected to grinding process. The production cost increases. The production requires a longer period.

The aforementioned plating process may allow addition of particles of fluoroplastic material into the solution. The particles serve to reduce friction between the inner surface of the annular spacer 42 and the outer surface of the spindle hub 33 when the annular spacer 42 is mounted on the spindle hub 33.

The annular member may be subjected to maturing process when the mixed material contains the hydraulic powder. The maturing process may utilize at least one of steam under normal atmosphere, steam under a pressurized atmosphere, and hot water, as conventionally known. The water is supplied to the annular member based on the maturing process. The hydraulic powder gets cured or hardened based on reaction with the water. The maturing process serves to promote setting or hardening of the hydraulic powder. If the mixed material only contains non-hydraulic powder, the maturing process can be omitted.

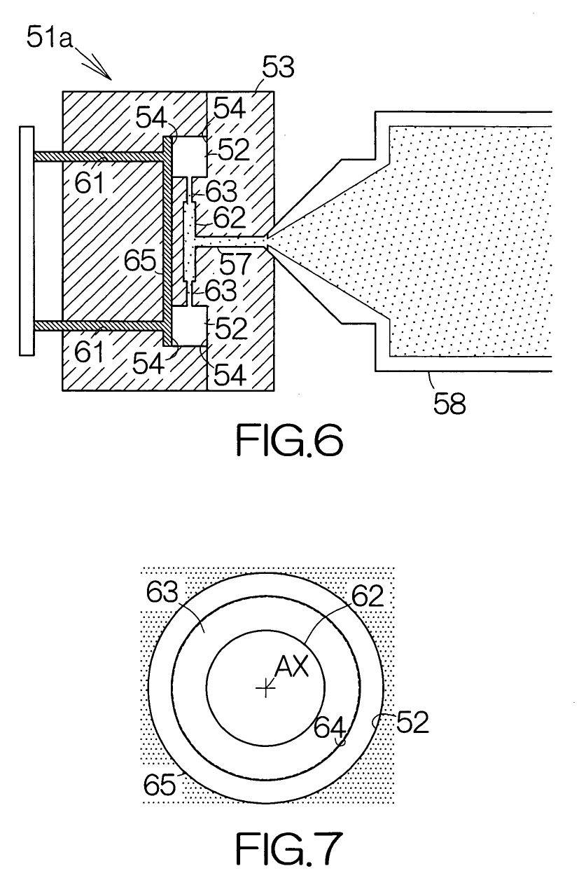

As shown in FIG. 6, a so-called disk gate and disk-shaped knock pin may be employed in the injection molding, for example. A disk-shaped reservoir 62 is connected to the runner 57 in the die 53 of an injection molding machine 51a. Referring also to FIG. 7, a gate 63 is connected to the overall outer periphery of the reservoir 62. The gate 63 opens all around the inner cylindrical surface of the cavity 52. The gate 63 opens along a predetermined datum circle 64 around the axis AX connecting the centers of the parallel annular flat inner surfaces 54, 54. A disk-shaped knock pin 65 is disposed at one of the parallel annular flat inner surfaces 54 of the cavity 52. The surface of the knock pin 65 is designed to serve as one of the parallel annular flat inner surfaces 54 of the cavity 52. The knock pin 65 extends within a circle set around the axis AX connecting the centers of the parallel annular flat inner surfaces 54. The knock pin 65 faces the cavity 52 in this manner.

The injection molding machine 51a allows the mixed material to uniformly flow into the cavity 52 through the gate 63 from the reservoir 62 at a uniform velocity. An unbalanced afflux of the mixed material can be avoided in the cavity 52. A final product molded in the cavity 52 is allowed to enjoy an improved dimensional accuracy. In addition, the knock pin 65 is shaped in a disk. The knock pin 65 is allowed to establish a uniform urging force all over the annular member. Imbalance of the urging force can be avoided. A partial deformation can be prevented in the annular member.

Otherwise, as shown in FIG. 8, a so-called plate knock may be employed in the injection molding. In this case, the reservoir 62 may likewise be connected to the runner 57 in the die 53 of an injection molding machine 51b. Annular knock pin 66 is disposed at one of the parallel annular flat inner surfaces 54 of the cavity 52. The knock pin 66 defines a part of the annular flat inner surface 54. The knock pin 66 extends along a datum circle set around the axis AX connecting the centers of the parallel annular flat inner surfaces 54. The knock pin 66 faces the cavity 52 in this manner.

The injection molding machine 51b allows the mixed material to uniformly flow into the cavity 52 through the gate 63 from the reservoir 62 at a uniform velocity. An unbalanced afflux of the mixed material can be avoided in the cavity 52. A final product molded in the cavity 52 is allowed to enjoy an improved dimensional accuracy. In addition, the knock pin 66 is shaped in an annular form. The knock pin 66 is allowed to establish a uniform urging force all over the annular member. Imbalance of the urging force can be avoided. A partial deformation can be prevented in the annular member.

The inventors have observed the characteristic of the annular spacer 42. The inventors have prepared an example of the annular spacer 42 according to the aforementioned method. The inventors prepared comparative examples. A first comparative example was made of a stainless steel. A second comparative example was made of alumina ceramic. A third comparative example was made of zirconia ceramic. Specific gravity, Young's modulus, coefficient of linear expansion and thermal conductivity were measured for the example of the annular spacer 42 and the comparative examples.

As shown in Table 1 below, the annular spacer 42 has exhibited the smallest specific gravity as compared with the comparative examples. The annular spacer 42 is thus allowed to enjoy a remarkably reduced weight. A moderate acceleration and deceleration can be established for rotation,of the spindle hub 33 receiving the annular spacer 42. Eccentricity can be reduced in the magnetic recording disks 13 relative to the longitudinal axis 35 of the rotation shaft 32. Run-out can be suppressed in the rotating magnetic recording disks 13.

TABLE 1

| | | Compar. | Compar. | Compar. | Ex of |
|---|---|---|---|---|---|
| | Glass | Ex. 1 | Ex. 2 | Ex. 3 | Invent. |
| Specific | 2.50 | 7.93 | 3.90 | 6.00 | 1.90 |
| Gravity | | | | | |
| Young's | 80-100 | 193 | 350-400 | 250 | 280 |
| Modulus | | | | | |
| [GPa] | | | | | |
| Liner | 7.0-9.0 | 17.2 | 6.4-8.0 | 8.0-9.0 | 8.0-10.0 |
| Expansion | | | | | |
| [×10⁻⁶/K] | | | | | |
| Thermal | 0.8 | 16 | 20-30 | 2.1 | 1.3 |
| Conductivity | | | | | |
| [W/mK] | | | | | |

Moreover, the annular spacer 42 exhibits a Young's modulus and a coefficient of linear expansion similar to those of the second and third comparative examples. The coefficient of linear expansion of the annular spacer 42 can be matched with that of the glass. A relative displacement can be avoided between the magnetic recording disks 13 and the annular spacer 42 even when the temperature rises in the rotating magnetic recording disks 13 and annular spacer 42. The magnetic recording disks 13 can stably be fixed on the spindle hub 33 at a higher accuracy. Run-out or eccentricity of the magnetic recording disks 13 can be suppressed. An improved recording density can be expected in the HDD 11.

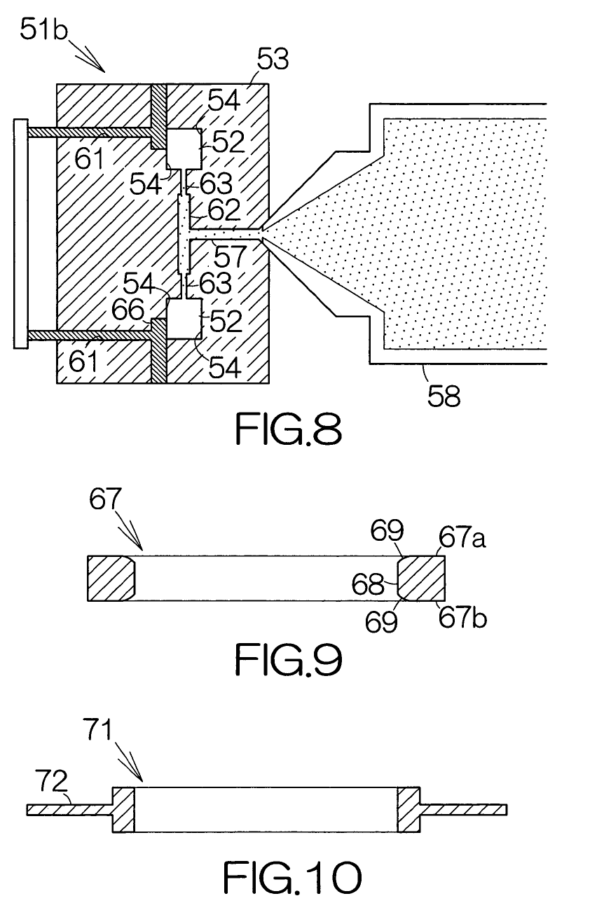

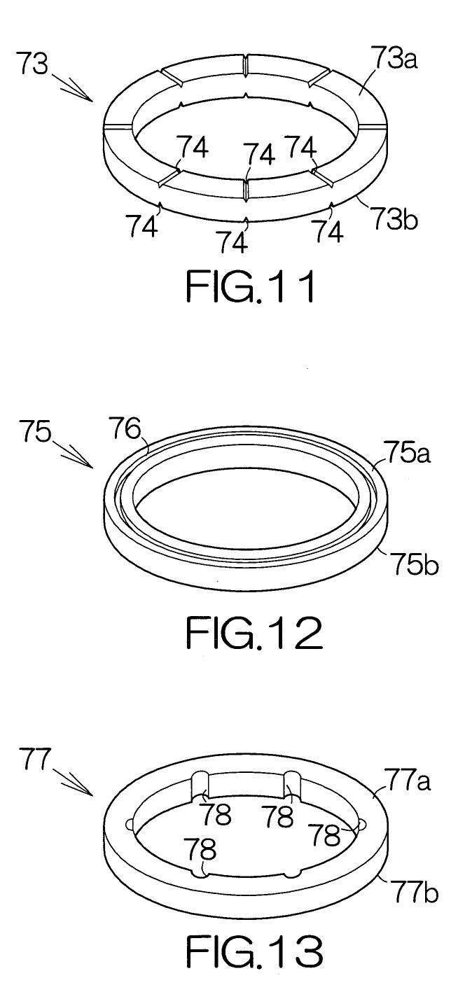

As shown in FIG. 9, an annular spacer 67 may further include chamfer surfaces 69 connecting the first and second flat surfaces 67a, 67b to an inner periphery 68, for example. The chamfer surfaces 69 may comprise a curved surface. Otherwise, anannular spacer 71 may further include a protrusion or flange 72 extending outward from the overall outer periphery, as shown in FIG. 10. As shown in FIG. 11, an annular spacer 73 may further include grooves 74 formed on the first and second annular flat surfaces 73a, 73b. The grooves 74 may extend radiately from an axis connecting the centers of the first and second annular flat surfaces 73a, 73b, for example. The grooves 74 may be arranged at equally spaced location in the circumferential direction. As shown in FIG. 12, an annular spacer 75 may further include grooves 76, 76 formed on the first and second annular flat surfaces 75a, 75b. The grooves 76 may extend all over in the circumferential direction of the first and second annular flat surfaces 75a, 75b, for example. As shown in FIG. 13, an annular spacer 77 may further include depressions 78 formed on the inner periphery. The depressions 78 may be defined as a semicylinder extending in parallel with an axis connecting the centers of the first and second annular surfaces 77a, 77b.

The aforementioned method may be utilized to form the annular spacers 67, 71, 73, 75, 77. An injection molding process may be applied in the aforementioned manner. The die of the injection molding machine may correspond to the shape of the annular spacer 67, 71, 73, 75, 77. The annular spacers 67, 71, 73, 75, 77 can thus be made in a facilitated manner. The method of the invention may be applied to any shape of the annular spacer.

What is claimed is:

1. A spacer for a recording disk drive, comprising
an annular member having upper and lower flat surfaces extending in parallel with each other, wherein
said annular member is made of a mixed material at least including first inorganic powder having particle size in a range from 10 μm to 100 μm, second inorganic powder having particle size in a range from 0.01 μm to 1 m, and resin material, said resin material being contained in the mixed material at an amount equal to or smaller than 40 volume % to a total amount of the mixed material.

2. The spacer according to claim 1, wherein said first and second inorganic powder include at least either oxides or continuous solid solutions, said oxides including one element selected from a group consisting of Si, Fe, Al and Ca, said continuous solid solutions including at least two elements selected from the group.

3. The spacer according to claim 1, wherein said upper and lower flat surfaces have a flatness equal to or smaller than 2 μm.

4. The spacer according to claim 1, wherein said annular member is covered with an electrically conductive layer.

5. A recording disk drive comprising:
a rotation body;
recording disks mounted on the rotation body; and
a spacer mounted on the rotation body between the recording disks, said spacer having upper and lower flat surfaces extending in parallel with each other, wherein
said spacer is made of a mixed material at least including first inorganic powder having particle size in a range from 10 μm to 100 μm, second inorganic powder having particle size in a range from 0.01 m to 1 μm, and resin material, said resin material being contained in the mixed material at an amount equal to or smaller than 40 volume % to a total amount of the mixed material.

6. A spacer for a recording disk drive, comprising
an annular member having upper and lower flat surfaces extending in parallel with each other, wherein
said annular member is made of a mixed material including a constituent and resin material, said constituent getting hardened based on reaction with a predetermined material, said resin material being contained in the mixed material at an amount equal to or smaller than 40 volume % to a total amount of the mixed material.

7. A recording disk drive comprising:
a rotation body;
recording disks mounted on the rotation body; and
a spacer mounted on the rotation body between the recording disks, said spacer having upper and lower flat surfaces extending in parallel with each other, wherein
said spacer is made of a mixed material including a constituent and resin material, said constituent getting hardened based on reaction with a predetermined material, said resin material being contained in the mixed material at an amount equal to or smaller than 40 volume % to a total amount of the mixed material.

8. A method of making a spacer for a recording disk drive, comprising:
preparing a mixed material at least including first inorganic powder having particle size in a range from 10 μm to 100 μm, second inorganic powder having particle size in a range from 0.01 m to 1 μm, and resin material, said resin material being contained in the mixed material at an amount equal to or smaller than 40 volume % to a total amount of the mixed material; and
molding an annular member based on the mixed material, said annular member having upper and lower annular flat surfaces extending in parallel with each other.

9. The method according to claim 8, wherein said first and second inorganic powders are made of either oxides or continuous solid solutions, said oxides including one element selected from a group consisting of Si, Fe, Al and Ca, said continuous solid solutions including at least two elements selected from the group.

10. The method according to claim 8, further comprising effecting grinding process on the annular member so as to establish a flatness equal to or smaller than 2 μm on the upper and lower annular flat surfaces.

11. The method according to claim 8, further comprising effecting plating process on the annular member with an electrically conductive material.

12. The method according to claim 11, further comprising subjecting the annular member to at least any one of blasting process, etching process and surface activating process prior to the plating process.

13. The method according to claim 8, wherein said mixed material is formed in a cavity of a die, said cavity being defined between parallel annular flat inner surfaces of the die.

14. The method according to claim 13, wherein said mixed material is injected in the cavity through gates located at equally spaced positions along a predetermined datum circle around an axis connecting centers of the parallel annular flat inner surfaces.

15. The method according to claim 13, wherein knock pins are located for inward and outward movements relative to the cavity at equally spaced positions along a predetermined datum circle around an axis connecting centers of the parallel annular flat inner surfaces.

16. The method according to claim 13, wherein said mixed material is injected in the cavity through a gate extending along an entire predetermined datum circle set around an axis connecting centers of the parallel annular flat inner surfaces.

17. The method according to claim 13, wherein a knock pin is located for inward and outward movements relative to the cavity, said knock pin defining one of the parallel annular flat inner surfaces over a surface of the knock pin itself.

18. A method of making a spacer for a recording disk drive, comprising:
preparing a mixed material including a constituent and resin material, said constituent getting hardened based on reaction with a predetermined material, said resin material being contained in the mixed material at an amount equal to or smaller than 40 volume % to a total amount of the mixed material; and
molding an annular member based on the mixed material, said annular member having upper and lower annular flat surfaces extending in parallel with each other.

19. The method according to claim 18, further comprising subjecting the annular member to maturing process utilizing at least any one of steam under normal atmosphere, steam under a pressurized atmosphere, and hot water.
